(19) United States
(12) Patent Application Publication
(10) Pub. No.: US 2016/0023498 A1
(43) Pub. Date: Jan. 28, 2016

(54) Modular letter tray kit with attachable desk accessories

(71) Applicant: Michael Russell Durnen, Spokane, WA (US)

(72) Inventor: Michael Russell Durnen, Spokane, WA (US)

(21) Appl. No.: 14/121,024

(22) Filed: Jul. 22, 2014

(51) Int. Cl. B42F 7/10

(52) U.S. Cl. CPC B42F 7/10

(57) ABSTRACT

Plastic letter trays that are sold in a disassembled condition as individual components and later assembled by the end user to form a customized letter tray that is capable of storing documents and attaching desk accessories vertically to the out side of the letter tray side panels to save desk space.

### RELATED APPLICATIONS

The present application is a continuation-in-part application of related to and claims prioity to U.S. provisional patent application, Ser. No. 61/958,505, filed Jul. 30, 2013, for DESKUBE, by Michael R. Durnen, included by reference herein and for which benefit of the priority date is hereby claimed. Application no. 61/958,505 is hereby incorporated by reference in its entirety.

### FIELD OF THE INVENTION

The present invention relates to plastic letter trays . . . and, more particularly, to letter trays that are sold in a disassembled condition as individual components and later assembled by the end user to form a customized letter tray that is capable of storing documents and attaching desk accessories vertically to the out side of the letter tray side panels to save desk space.

### BACKGROUND OF THE INVENTION

It has been well established that plastic desktop letter trays formed as a one piece design are substantially bulky and as such expensive to ship, store and require a lot of retail shelf space to display for sales. Current prior art U.S. Pat. No. 5,624,037 issued Apr. 29, 1997 to Kozo entitled Collapsible Letter Tray Kit and patent application US 2011/0078095 A1 Pub. Mar. 31, 2011 issued to Eckhardt entitled Plastic Letter Tray Assembly Kit shows plastic letter trays that are manufactured in a design that allows for a compact form that reduces the volume needed to ship and store product and can be configured by the end user to form a standard letter tray for the desk top that can be used for the storage of documents and stacked vertically to save desk space.

While the prior art solves the issues regarding the reduced volume needed to ship and store letter tray products so as to reduced the cost associated with the standard letter trays that are formed as one piece. There are several deficiencies regarding these disassembled letter tray designs. One disadvantage to these designs is that once assembled and stacked you have no option as to the final configuration.

Another problem with the current prior art is that once the letter tray is assembled and stacked the outside vertical surfaces formed by the stacked letter trays are not being used for the mounting of desk accessories that are normally place on the desk. Another problem with the prior art is that it can't be updated or changed at a latter date by adding different letter tray shelf styles.

Further disadvantage of the prior art is the floors of the letter tray are fixed into positron and can not be adjusted to form various opening sizes.

It is an object of this invention to have a letter tray that can be assembled in a configuration that meets the needs of the end user.

It is another object of this invention for the end user to determine the spacing of the letter tray shelf opening.

It would also be advantageous to provide a letter tray that uses the outside vertical surfaces of the letter tray to attach desk accessories to in order to save desk space.

Another object of this invention is to form a file/letter sorter from individual letter tray parts purchased by the end user.

It is a further object of the invention to provide a letter tray with tray shelves that can be fixed or pulled out to provide a drawer function for easy access.

### SUMMARY OF THE INVENTION

In accordance with the present invention, there is provided . . . a letter tray kit consisting of including individual parts that can be packaged, separately and purchased by the end user to configure a letter tray that is customized to each individual users need. Further this invention allows for the desk accessories to be purchased individually and attached to the vertical sides of the letter tray so as to save desk space. Also, provided is the ability to use parts of the individually purchased letter tray parts to configure a file/letter sorter.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective and side view of a side panel;

FIG. 2 is a perspective view, end view and a side view of the side panel connector;

FIG. 3 is a perspective view of a letter tray shelf insert type x and letter tray small parts bin insert type y;

FIG. 4 is a perspective and top view of a mounting bracket and perspectice view of the locking push pin;

FIG. 5 is a perspective and top view of the desk accessories, stamp holder 40 small parts bin 41, pencil/pen holder 42 and business card holder 43;

FIG. 6 is a perspective view of a letter tray frame 50 assembled from 2 side panels and 2 side panel connectors;

FIG. 7 is an exploded view of an assembled letter tray with frame 2 type x tray inserts with desk accessories 40, 41, 42, 43; and

FIG. 8 is a perspective view of an assembled file/letter sorter.

For purposes of clarity and brevity, like elements and components will bear the same designations and numbering throughout the Figures.

### DESCRIPTION OF THE PREFERRED EMBODIMENT

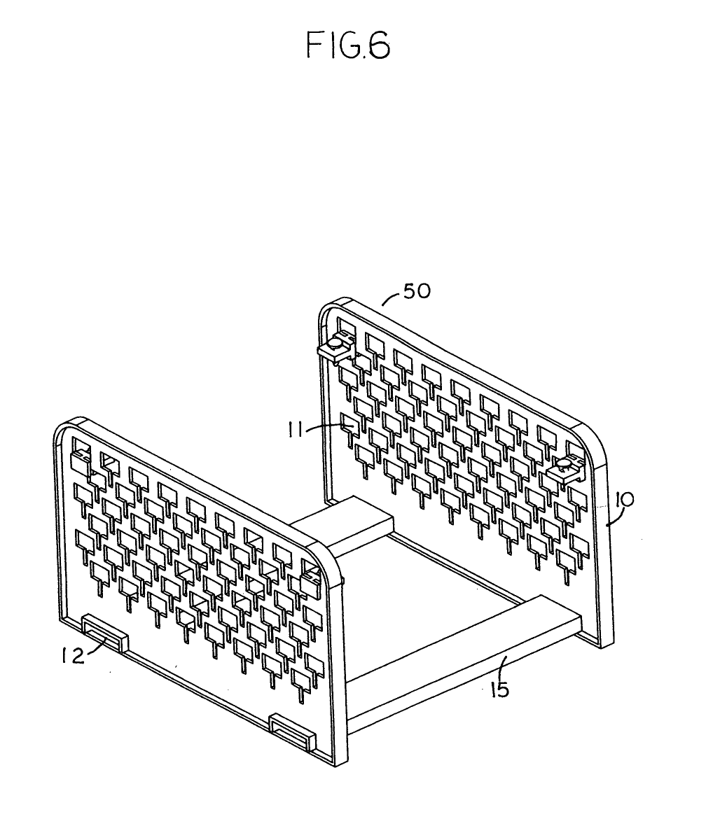

Turning to the drawings and referring to FIG. 6 is a perspective view of present invention of a letter tray frame 50. which is assembled using 2 side panels, or other flat members 10 each having a plurality of key slots 11 and 2 U channel openings 12 connected with 2 panel connectors 15, each having a plurality of molded indentations to allow for the side panels 10 to be snapped to the panel connectors 15 .

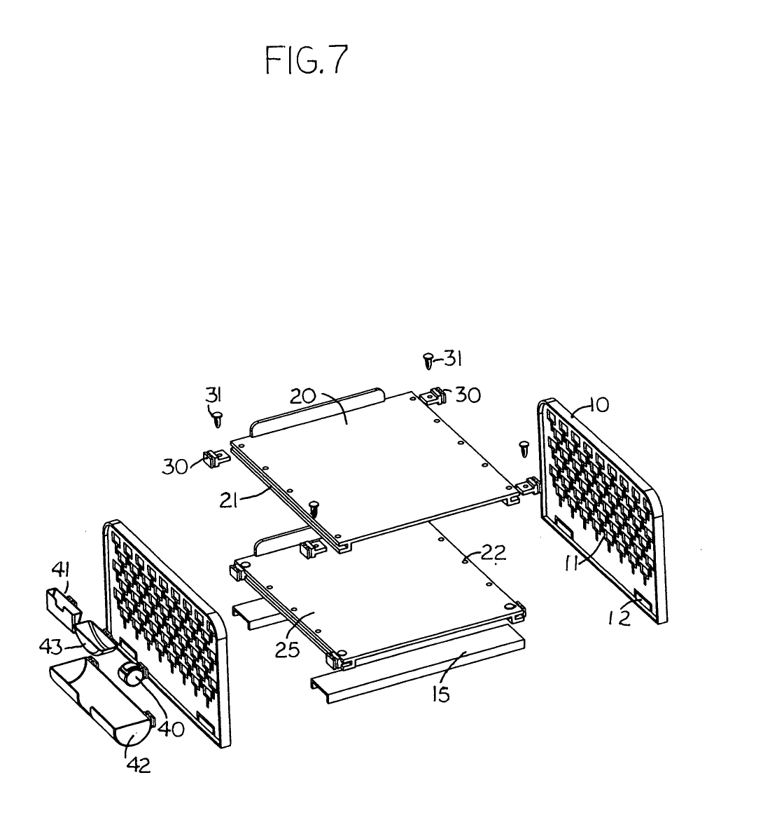

As shown in FIG. 7, the frame 50 being the major component that all other individual letter tray parts are connected to, such as insert type x 20, insert type y 25, mounting bracket 30 and push pin 31, and desk accessories stamp holder 40, small parts bin 41, pencil/pen holder 42, and business card holder 43 are molded of conventional plastic material by conventional means, preferably injection molding.

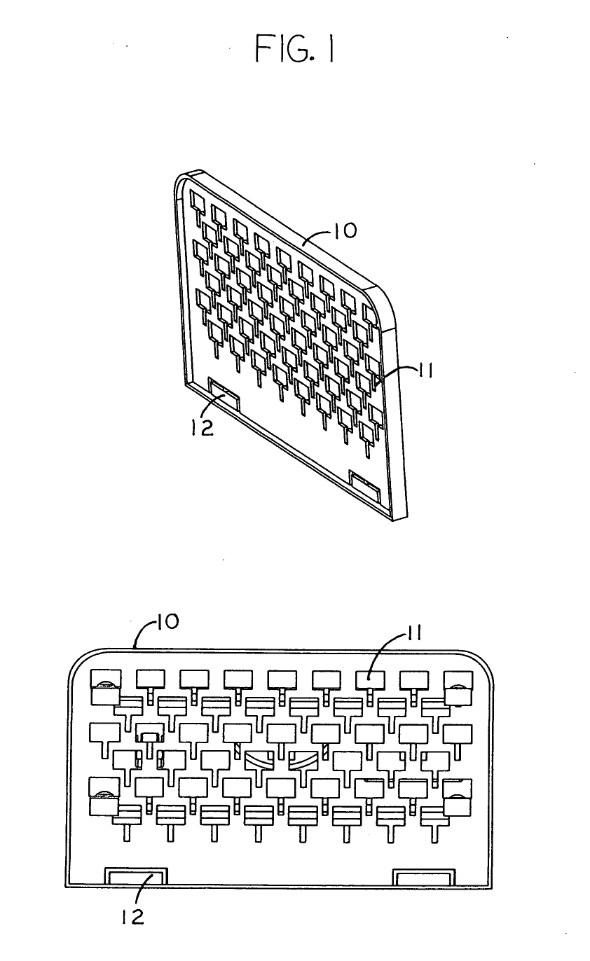

Turning to FIG. 1, 2, 3, 4, 5 that represent the individual modular parts that comprise the basic letter tray kit. As will be evident to those having ordinary skill in the art, the disclosed letter tray kit can have many configurations depending on the individual parts that are chosen by the end user and how they are configured to the letter tray frame 50 as you see in FIG. 7, 8, 9. These are just a few configurations of the preferred embodiment

FIG. 1 is a perspective view of the letter tray side panel 10 with a plurality of key hole mounting slots 11 and 2 U channel openings 12 at the base of the side panel 10 to accept the 2 panel connector 15 to form the letter tray frame 50. The side panel 10 is constructed so as to be reversible and suitable for both right and left side panels 10 of the frame 50. In the preferred embodiment the side panel 10 would be 6 inches high, but other panel heights, such as 9 inches and 12 inches can be made available providing more choices for the end user to customize the letter tray to fit their needs for document organization and storage.

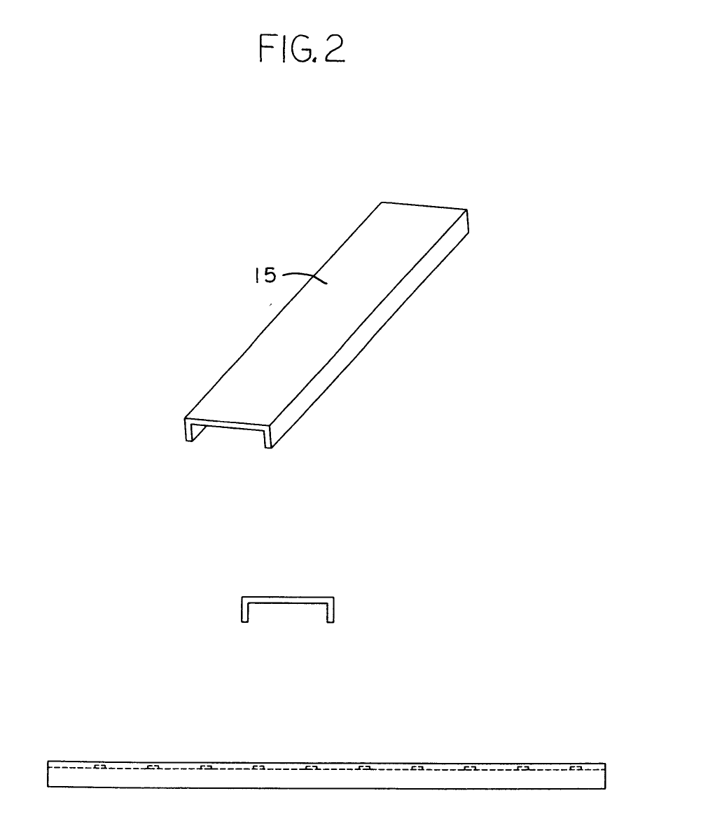

FIG. 2 is a perspective view of view of a letter tray panel connector 15 with a plurality of evenly space indentations on the underside so as to allow for a snug fit while inserted into the bottom U channels 12 at the base of the side panel 10

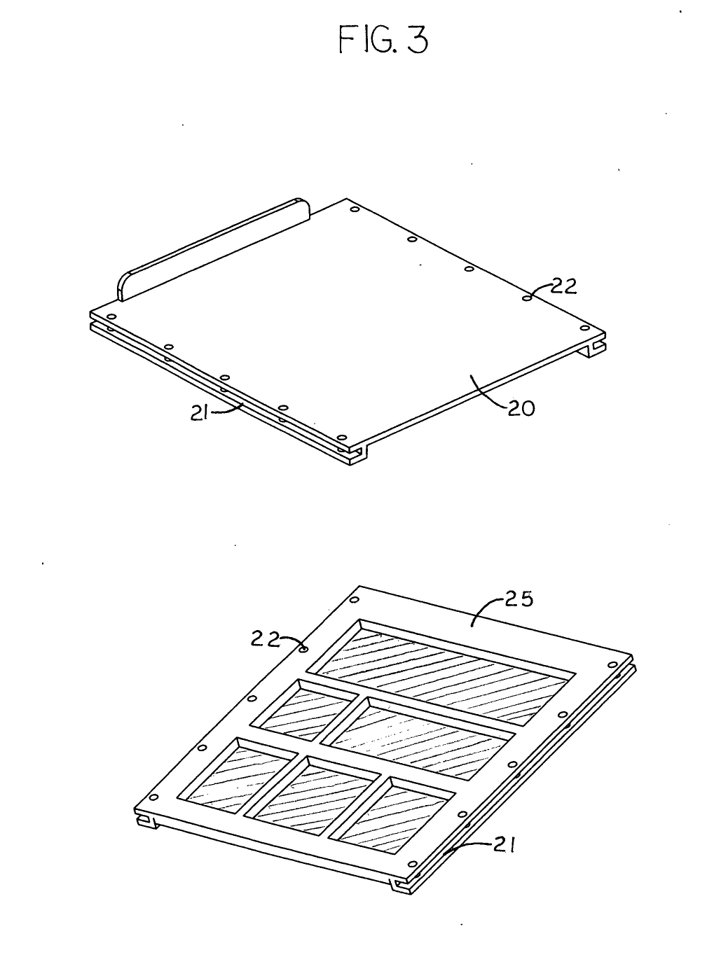

FIG. 3 is a perspective view of view of a letter tray shelf insert type x 20 and small parts tray shelf insert type y 25 with a plurality of evenly spaced holes 21 to accept locking push pins 31. Shelf inserts can be be locked into place by using the push pin 31 or can be pulled out such as one would a drawer when the push pin 31 is not inserted into the mounting bracket 30 to lock the tray shelf to the frame 50

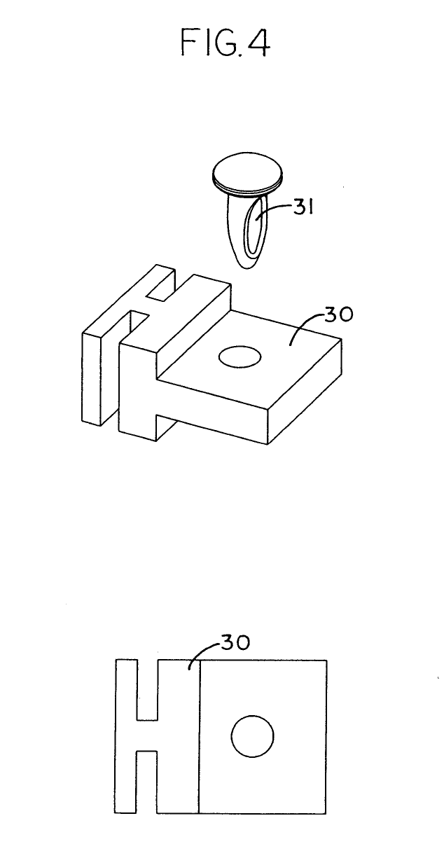

FIG. 4 is a perspective view of mounting bracket 30 and locking push pin 31 that are used for attaching the tray shelf inserts 20 and 25 to the frame 50 that has a plurality of key slots 11 so as to allow the placement of insert type x 20 and insert type y 25 in a combination of both quantity and type that meets the needs of the individual user

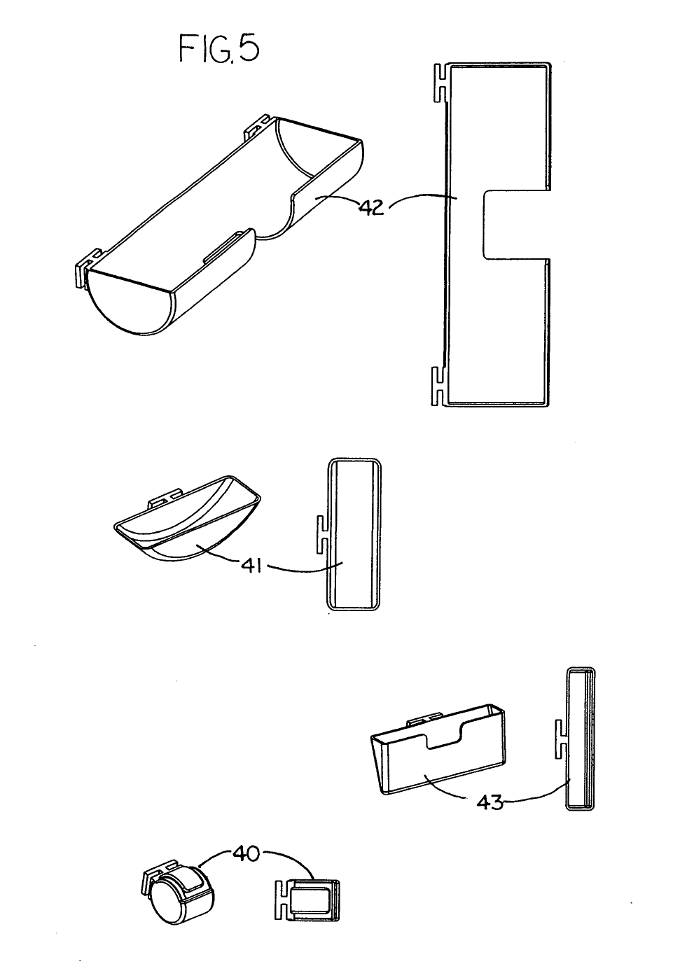

FIG. 5 is a perspective and top view of a desk accessories stamp holder 40, small parts bin 41, pencil/pen holder 42, business card holder 43. Top view shows the attached mounting brackets that are inserted into the slots 11 of the frame 50 securing the desk accessories 40, 41, 42, 43 to the outside of the frame 50. These desk accessories are molded so as to fit both right and left side panel 10 of the letter tray frame 50 In the particular embodiment shown, it is clear to those skilled in the art that many other type and styles of desk accessories would be possible and the current desk accessories are used as examples to illustrate the space saving feature of this invention.

FIG. 6 is a perspective view of letter tray frame 50 assembled from 2 side panel 10 and 2 side panel connectors which serves the basis for configuring a letter tray from selected trays inserts and desk accessories that meets the needs of the end user.

FIG. 7 is a exploded view of an letter assembly with desk accessories 40, 41, 42, 43 positioned to be attached to the outside of the letter tray frame 50 so as to save desk space by placing them to the vertical sides of the frame 50 and removing them off the desk and thus utilizing the vertical space of the letter tray frame 50 to store desk accessories that is normally wasted by other letter tray designs

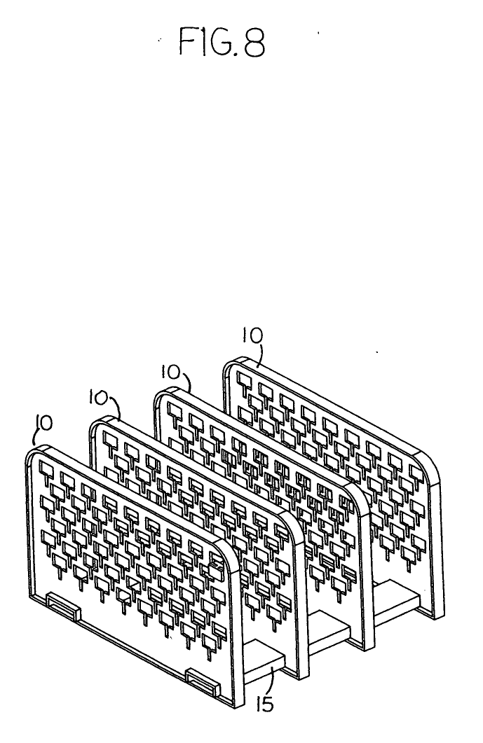

FIG. 8 is a perspective view of an assembled file/letter sorter that is another embodiment of this invention that allows the modular parts to be configured for other uses that are not related to letter tray type products.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

While the embodiments shown are preferred, it is not necessary for the tray panel connectors to be U-channel; they can be solid or of any other cross-section, there can be any number of connectors including only one, and if more than one, they do not have to be parallel. In addition, the tray panel connectors do not have to be perpendicular to the side panels, and the side panels do not have to be rectangular. Finally, while keyholes are shown to mount shelves, any way of mounting shelves to panels is within the scope of the present invention.

Having thus described the invention, what is desired to be protected by Letters Patent is presented in the subsequently appended claims.

I claim:

1. A letter tray comprising:
a plurality of substantially rectangular flat members arranged vertically and parallel to one-another, each flat member having a top and bottom edge and a front and rear face, the flat members connected by one or more parallel U-channel members perpendicular to the flat members and running between the flat members through rectangular slots near the bottom edges;
wherein each of the U-channel members has a plurality of indentations on an underside adapted to allow the flat members to snap-fit to the U-channel members at a plurality of separations between the flat members;
each of the flat members having a plurality of key hole mounting slots penetrating through the flat member from the front face to the rear face that are adapted to allow mounting of one or more horizontal shelves between the flat members at a plurality of heights and locations using removable mounting brackets configured to fit into the key hole mounting slots.

2. The letter tray of claim 1 wherein the removable mounting brackets are secured with push pins.

3. The letter tray of claim 1 further comprising two types of horizontal shelves, a flat continuous shelf, and a shelf with indentations adapted to receive accessories.

4. The letter tray of claim 1 further comprising a stamp holder configured to be attached to a face of a flat member.

5. The letter tray of claim 1 further comprising a small-parts bin configured to be attached to a face of a flat member.

6. The letter tray of claim 1 further comprising a pencil/pen holder configured to be attached to a face of a flat member.

7. The letter tray of claim 1 further comprising a business card holder configured to be attached to a face of a flat member.

8. The letter tray of claim 1 wherein the flat members are reversible front-to-back.

9. The letter tray of claim 1 with two U-channel members.

10. A letter tray comprising:
a pair of substantially rectangular flat members arranged vertically and parallel to one-another, each flat member having a top and bottom edge and a front and rear face, the flat members connected by a pair parallel U-channel members perpendicular to the flat members and running between the flat members through rectangular slots near the bottom edges;
wherein each of the U-channel members has a plurality of indentations on an underside adapted to allow the flat members to snap-fit to the U-channel members at a plurality of separations between the flat members;
each of the flat members having a plurality of key hole mounting slots penetrating through the flat member from the front face to the rear face that are adapted to allow mounting of one or more horizontal shelves between the flat members at a plurality of heights and locations using removable mounting brackets configured to fit into the key hole mounting slots.

11. The letter tray of claim 10 wherein the removable mounting brackets are secured with push pins.

12. The letter tray of claim 10 further comprising two types of horizontal shelves, a flat continuous shelf, and a shelf with indentations adapted to receive accessories.

13. The letter tray of claim 10 wherein the flat members are reversible front-to-back.

14. The letter tray of claim 10 further including accessories attachable to the flat members, wherein the accessories include a stamp holder, pencil/pen holder, small-parts bin or business card holder.

15. A letter tray comprising:
a plurality of flat members arranged vertically and parallel to one-another, each flat member having a top and bottom and a front and rear face, the flat members connected by one or more connecting members running between the flat members through slots;
wherein each of the connecting members is adapted to allow the flat members to snap-fit to the connecting members at a plurality of separations between the flat members;
each of the flat members having a plurality of mounting members that are adapted to allow mounting of one or more horizontal shelves between the flat members at a plurality of heights and locations.

16. The letter tray of claim 15 wherein the connecting members are U-channels.

17. The letter tray of claim 15 wherein the flat members are substantially rectangular.

18. The letter tray of claim 15 wherein the mounting members are holes in the flat members adapted to receive mounting brackets.

19. The letter tray of claim 15 wherein the connecting members are parallel to one-another when there is more than one connecting member.

20. The letter tray of claim 15 wherein the connecting members are perpendicular to the flat members and pass through a slot in the flat members.
